(19) United States
(12) Patent Application Publication
(10) Pub. No.: US 2011/0300640 A1
(43) Pub. Date: Dec. 8, 2011

(54) METHOD AND DEVICE FOR AUTHENTICATING OBJECTS PROVIDED WITH A MARKER, THE SPECIFICATION OF WHICH:

(75) Inventors: Andre Josten, Nurnberg (DE); Christian Wolfrum, Erlangen (DE)

(73) Assignee: Secutech International Pte. Ltd.

(21) Appl. No.: 12/307,107

(22) PCT Filed: Jul. 3, 2007
(86) PCT No.: PCT/EP2007/005884

§ 371 Date: Nov. 2, 2009

(30) Foreign Application Priority Data
Jul. 3, 2006 (DE) 10 2006 031 015.2

(51) Int. Cl. G01N 21/64; B01L 3/02

(52) U.S. Cl. 436/501; 422/521

(57) ABSTRACT

The invention relates to a method for authenticating objects provided with a marker that contains nucleic acid.

The invention relates to a method and a device for authenticating objects provided with a mark.

WO 01/51652 A2 discloses a method in which, for authentication, an object is provided with a forgery-proof mark. The mark consists of a first nucleic acid, which is arranged in the form of first area elements. For identification of the mark, a partial pattern formed by the first area elements is made visible. For this, the first nucleic acid is brought into contact with a second nucleic acid complementary thereto. Upon hybridization of the first and the second nucleic acid, fluorescence can be observed. For measuring a background signal, second area elements, containing a third nucleic acid, can be provided in addition to the first area elements. The third nucleic acid is not complementary to the second nucleic acid. Hybridization does not occur between the second and the third nucleic acid. The background fluorescence can be determined by measuring the fluorescence of the second area elements.

WO 02/072878 A1 describes a method in which an object is provided with a mark for authentication. The mark comprises a first and a second area element. The first area element is impregnated with a predefined first nucleic acid and the second area element is impregnated with a predefined third nucleic acid. For authenticating the object, the first and the second area element are contacted with a detection solution. The detection solution contains a second nucleic acid that is complementary to the first nucleic acid, and is labeled with a fluorophore. As a result of hybridization of the first nucleic acid and the complementary second nucleic acid, an increased fluorescence signal can be observed. In contrast, contact of the second and of the third nucleic acid in the second area element does not lead to hybridization. Increased fluorescence cannot be observed there. Measurement of the fluorescence in the first and the second area element makes it possible to identify the mark.

In practice, the second nucleic acid usually employed is a nucleic acid having a hairpin structure, at the first free end of which the fluorophore is bound and at the opposite second free end of which a quencher is bound at a distance which causes a fluorescence signal to be quenched. Upon contacting the second nucleic acid with the first nucleic acid the hairpin structure opens up due to the hybridization to be achieved, and the spatial relationship between the fluorophore and the quencher is dissolved. As a result, the fluorescence signal can be observed.

The methods disclosed in the prior art are disadvantageous in several respects. Carrying out an exact measurement always requires area elements in the mark which are loaded with different nucleic acids. Preparing the mark is thus complicated. Apart from this, testing the authenticity of the mark requires measuring and evaluating the fluorescence of both the first and the second area element. Finally, it is also possible for physical or chemical processes to cause unspecific fluorescence in the first area element, possibly leading to false-positive or false-negative results. For example, a problem which may occur is that of the hairpin structure mentioned being possibly removed due to not only hybridization with the complementary first nucleic acid but also other influences. The hairpin structure may be destroyed by treating the second nucleic acid with acids or bases or by exceeding a certain temperature. Thus, for example, impregnation of the mark with an acid may generate a false-positive fluorescence signal and thereby simulate the authenticity of the object.

It is the object of the invention to remove the disadvantages of the prior art. More specifically, it is intended to provide a method for authentication of objects provided with a mark, which method can be carried out very easily and is distinguished by improved security against forgery and by improved reliability. It is also intended to provide a device suitable for carrying out the method.

This object is achieved by the features of claims 1, 17 and 19. Useful embodiments of the invention arise from the features of claims 2 to 16 and 18.

According to the invention, a method for authenticating objects provided with a mark is provided, said mark comprising a mark nucleic acid, wherein the method comprises:
a) providing a reference solution, which contains a reference nucleic acid that is double-stranded at least in sections, wherein the reference nucleic acid strands of the reference nucleic acid are not complementary to the mark nucleic acid, and wherein a first fluorophore is bound to one reference nucleic acid strand and a first quencher is bound to the other reference nucleic acid strand at a distance that quenches a first fluorescence signal of the first fluorophore,
b) providing a detection solution that is separate from the reference solution, which contains a detection nucleic acid that is double-stranded at least in sections, wherein one of the two detection nucleic acid strands is complementary to the mark nucleic acid at least in sections, and wherein a second fluorophore is bound to one detection nucleic acid strand and wherein a second quencher is bound to the other detection nucleic acid strand at a distance that quenches a second fluorescence signal of the second fluorophore,

c1) contacting the reference solution with the mark under conditions suitable for hybridization of one of the two detection nucleic acid strands with the mark nucleic acid,

c2) observing a first fluorescence signal emitted by the mark,

d1) contacting the detection solution with the mark under the conditions as in step c1),

d2) observing a second fluorescence signal emitted by the mark and

wherein steps d1) and d2) are carried out either before or after steps c1) and c2),

and
e) establishing authenticity of the object, if (i) for the first fluorescence signal observed in step c2) at least one expected first property of the first fluorescence signal is not observed, and if (ii) the second fluorescence signal observed in step d2) corresponds to at least one expected second property of the second fluorescence signal.

The two reference nucleic acid strands of the reference nucleic acid are not complementary to the mark nucleic acid. Upon contacting the reference nucleic acid with the mark nucleic acid, the double-stranded structure of the reference nucleic acid is preserved. A first fluorescence signal cannot be observed or does not exceed a predefined threshold value. If there is a fault with the mark, for example, if substances such as acids, bases or the like have been contaminated or applied for purposes of falsification, or if the contacting of the detection solution with the mark takes place under conditions, for example excessive temperature, in which a double-stranded structure of two nucleic acids is separated, the expected first property of the first fluorescence signal can be observed. For example, a fluorescence intensity that exceeds the predefined threshold value can be observed. This indicates that there is a false-positive measurement. Therefore, high reliability and security against forgery of the method can be ensured simply, safely and reliably.

One detection nucleic acid strand is complementary in sections to the mark nucleic acid at least to the extent that upon contacting the mark nucleic acid with this detection nucleic acid strand, hybridization occurs under predefined conditions. None of the detection nucleic acid strands is complementary to the reference nucleic acid strands. Through hybridization of the detection nucleic acid strand with the mark nucleic acid, the spatial relation between the second quencher and the second fluorophore is cancelled. Consequently, when light impinges on the second fluorophore there is observable fluorescence.

The mark is preferably fixed firmly on the surface of the object. To authenticate the object, it is not necessary to remove the mark. Advantageously, the mark can be identified in place, i.e. attached to the surface of the object. This makes the proposed method particularly easy to carry out.

According to the proposed method, the mark nucleic acid is advantageously first brought in contact with the reference solution and the first fluorescence signal (if any) emitted by the mark is observed. If the first fluorescence signal exceeds a defined threshold value, this shows that interfering substances have been added to the mark or the test conditions are inadmissible. In this case it is no longer necessary for the mark nucleic acid then to be brought in contact with the detecting nucleic acid. A particular advantage of the proposed method is that for observation of the first and/or the second fluorescence signal it is possible to use a conventional hand-held fluorescence reader or a conventional fluorescence measuring instrument, with which in particular the intensity of the observed fluorescence signal can be determined quantitatively.

According to an advantageous embodiment of the invention, the first fluorophore and the first quencher are bound in the region of one end of the reference nucleic acid. The second fluorophore and the second quencher can similarly be bound in the region of one end of the detecting nucleic acid. Provision of the fluorophore/quencher pair in the region of the end of the reference nucleic acid and/or the detecting nucleic acid permits particularly simple production thereof. There is little disturbance of the double-stranded structure in the case of the proposed provision of the fluorophore/quencher pair in the end position.

According to an advantageous embodiment, steps c1) and c2) and steps d1) and d2) are carried out sequentially within 120 seconds, preferably within 60 seconds. This permits an in-situ authentication of the mark. Furthermore, in practice it is possible to ensure that the reaction conditions for carrying out the aforementioned steps are substantially the same. Steps c1) and c2) and steps d1) and d2) are preferably carried out at ambient temperature. In particular it is not necessary to provide special temperatures that deviate from ambient temperature.

According to an advantageous embodiment, the detection nucleic acid has a hairpin structure, in which the detection nucleic acid has two mutually complementary branches. Similarly, the reference nucleic acid can also have a hairpin structure, in which the reference nucleic acid strands have two mutually complementary branches. The proposed self-complementary detection and/or reference nucleic acids are suitable in particular for the detection of the mark nucleic acid or any substances or conditions that produce false-positive signals.

According to another embodiment, in step c2) and/or d2) the mark is irradiated with light of a predefined wavelength range. The wavelength range includes those wavelengths at which the first and/or the second fluorophore can be excited to produce a first and/or a second fluorescence signal. In this way the intensities of the fluorescence signals can be clearly increased relative to the background, thereby providing a particularly definite and reliable measurement. For further improvement of the luminous efficiency, the mark can be applied on a light-reflecting substrate.

According to another embodiment, both the detection solution and the reference solution are applied on a single detection field of the mark which contains the mark nucleic acid. Since only a single detection field is provided, detection of the fluorescence can be simplified.

Advantageously, in each case a predefined volume of the detecting and/or the reference solution is applied on the mark. This makes especially reliable authentication of the mark possible. A predefined volume can be applied with suitable liquid applicator devices. For example, it is possible to use a pipette or a first pen containing the detection solution and a second pen containing the reference solution. The use of said liquid applicator devices simplifies the handling and makes rapid in-place detection possible.

In each case at least one predefined expected property of the first and second fluorescence signals is measured. The expected first property of the first fluorescence signal can be a predefined first maximum intensity in a first wavelength range, and the expected second property can be a predefined second minimum intensity in a second wavelength range. To establish the authenticity of the object, the first and the second fluorophore can also differ with respect to the wavelength of the first and second fluorescence signals thus produced. For establishing the authenticity of the object, in this case measurements can be taken in the wavelength ranges of the first and of the second fluorescence signal. If in the first wavelength range a first fluorescence signal is observed with an intensity above a predefined maximum, or a ratio of the first to the second fluorescence signal is determined that is outside of an expected value, the mark is assessed as not authenticated.

According to an especially advantageous embodiment, the first and the second fluorophore are identical. The first and the second quencher can also be identical. In this case excitation can take place both after application of the reference solution and after application of the detection solution with the same wavelength range, i.e. with the same exciting light source. Moreover, observation of the emitted fluorescence can be carried out with one and the same fluorescence detecting device. In this way the costs of equipment for quantitative measurement or observation of the fluorescence can be reduced.

The first and second fluorescence signals can for example be detected with a hand-held fluorescence reader. For this, the hand-held fluorescence reader is put on the mark, light is produced for excitation of the first and/or the second fluorophore and the fluorescence emitted by the mark is determined. The intensities of the first and second fluorescence signals can be recorded successively, in each case in a predefined wavelength range. For determination of the authenticity of the mark, the measured intensities can be compared with expected values. If they coincide with the expected values, they are assessed as authenticated and if there is lack of agreement with the expected values they are assessed as not authenticated. Advantageously, the expected value can be a ratio between an expected first and second intensity. Instead of a ratio, however, it is also possible to use a difference or some other correlation of expected values or properties with the measured properties for detecting the intensity of the mark. The aforementioned expected values can be obtained on the basis of series of measurements on intact marks and on contaminated marks.

In the method according to the invention it is, advantageously, only necessary to observe the fluorescence emitted by the single detection field. In particular it is not necessary to move the hand-held fluorescence reader over the mark in order to record for example fluorescence emitted by a separate reference surface. This simplifies the method. Of course, it is also possible to provide the mark on a first mark field and provide a second reference field, which does not contain the mark nucleic acid. In this case the mark can be detected by applying the detection solution on the mark field and on the reference field and observing the fluorescence emitted both by the mark field and by the reference field. The fluorescence emitted by the reference field shows the background fluorescence. Since the signal representing the background fluorescence is related to the fluorescence signal emitted by the mark field, authentication of the mark can be particularly reliable.

Advantageously, the mark contains at least one additional nucleic acid, which is not complementary to the detection nucleic acid strands and is also not complementary to the reference nucleic acid strands. The additional nucleic acid can be contained in the mark in excess relative to the mark nucleic acid. The purpose of the additional nucleic acid is to conceal the mark nucleic acid or make it impossible for unauthorized persons to isolate it from the mark. This further increases the security of the mark against forgery. The additional nucleic acid can for be, example, calf thymus DNA, synthetic oligonucleotides with random sequences, tRNA, herring sperm DNA or plant DNA.

According to another embodiment of the invention, it is envisaged to use, as mark, a printing ink containing the mark nucleic acid and/or the additional nucleic acid. It was found, surprisingly, that reliable detection of the authenticity of the object can also be achieved when the mark nucleic acid is contained in a printing ink. By printing with printing ink containing the mark nucleic acid it is possible to produce, in a particularly simple and cost-effective manner, a mark that is not immediately recognizable by the layman, for example on documents, bank notes, tickets or the like.

The mark can be applied by a printing process on the object to be marked or on a, preferably self-adhesive, label. The label is preferably designed so that it cannot be removed nondestructively from the object.

According to another embodiment the mark comprises a mark surface, with a size of only a few square millimeters, preferably 1 to 20 mm². Such a mark can be produced inexpensively.

Production of the mark preferably uses 0.01 to 1.0 pmol of mark nucleic acid. Such small amounts of mark nucleic acid are difficult for forgers to isolate, to analyze and to imitate. This applies in particular when the mark nucleic acid is contained in the mark in a mixture with at least one additional nucleic acid.

To detect the mark nucleic acid, it is merely necessary to apply a few microliters of the detection solution on the mark. Advantageously, definite predefined volumes of the reference solution and the detection solution are applied on the mark. This ensures that the expected first and second fluorescence signals are within a narrow range of intensity. In particular it is unnecessary to immerse the mark in the detecting fluid or to wash the mark after applying the detecting fluid, in order to observe a suitable fluorescence emission for establishing authenticity. It is thus possible, in particular, to authenticate the object with the mark applied thereon. Application of the small amounts of detecting fluid does not affect the object in any way. The authenticity of the object can thus be established quickly and easily.

The invention further relates to a kit provided with a first fluid dispensing device containing the reference solution, wherein the reference solution contains a reference nucleic acid that is double-stranded at least in sections, wherein the reference nucleic acid strands of said reference nucleic acid are not complementary to a predefined mark nucleic acid, and wherein a first fluorophore is bound to one reference nucleic acid strand and a first quencher is bound to the other reference nucleic acid strand at a distance that quenches a first fluorescence signal of the first fluorophore, and with a second fluid dispensing device containing the detection solution, wherein the detection solution contains a detection nucleic acid that is double-stranded at least in sections, wherein one of the two detection nucleic acid strands is complementary at least in sections to the predefined mark nucleic acid, and wherein a second fluorophore is bound to one detection nucleic acid strand and a second quencher is bound to the other detection nucleic acid strand at a distance that quenches a second fluorescence signal of the second fluorophore.

Advantageously the first and the second fluid dispensing device are in each case a pen or a pipette containing the detecting or reference solution.

According to another embodiment, instead of the kit it is also possible to envisage a fluid dispensing device with a first container for holding the reference solution according to the invention and a second container for holding the detection solution according to the invention and a device for separate, sequential delivery of a predefined volume of the reference solution and of the detection solution. The fluid dispensing device can be a double pipette, which is provided with a suitable mechanism, actuation of which delivers first a predefined volume of reference solution and activation again then delivers a predefined volume of detection solution. This simplifies the operation of detection. A mistake in the order of applying the reference solution and the detection solution is precluded by the design of the equipment.

The marked object preferably comprises goods, articles, packaging and documents, and in particular proprietary products, currency, smart cards or packaging for these. The object to be authenticated is released by the manufacturer into free circulation and so is subject to a potential risk of forgery. The authenticity of the object can when required be determined reliably and with certainty using the method according to the invention. For this it is merely necessary for the detection solution, contained for example in a felt-tip pen, to be applied on the mark, and then the fluorescence emitted by the mark is observed with a hand-held fluorescence reader, analyzed or compared against predefined expected values, and authenticity of the mark is established on the basis of the result of comparison.

Examples of application of the invention are explained in more detail below, referring to the drawings, showing:

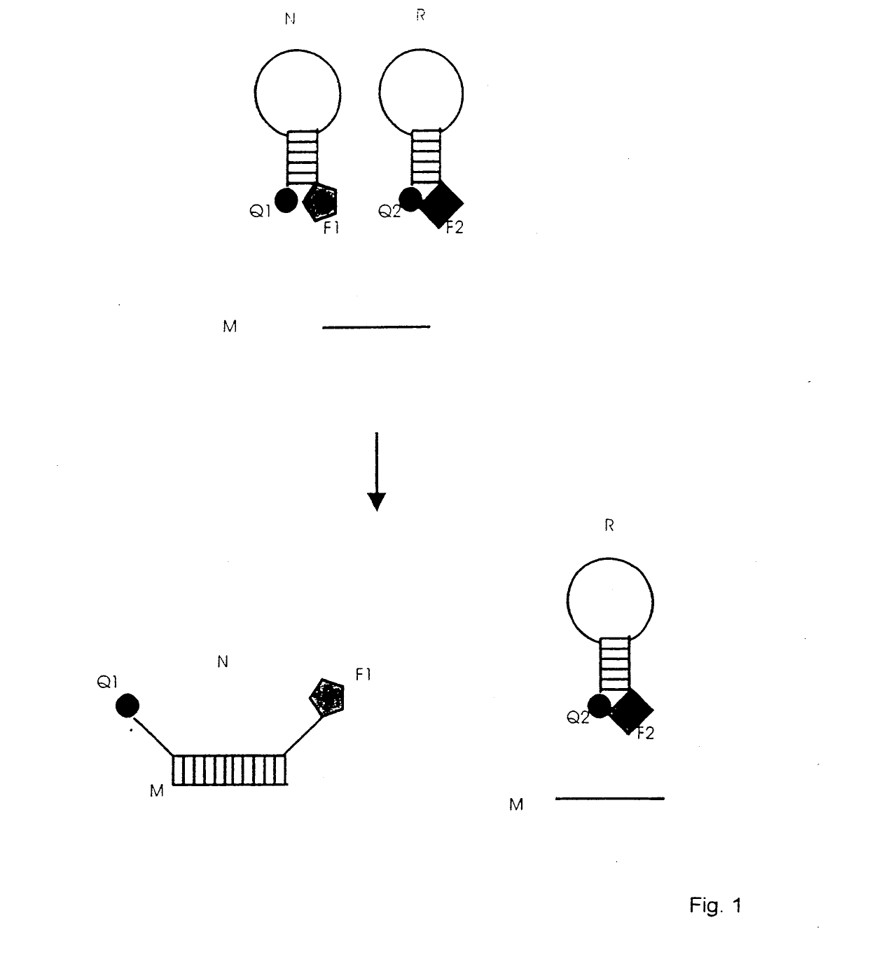

FIG. 1 schematically, a mark nucleic acid, a detection nucleic acid and a reference nucleic acid,

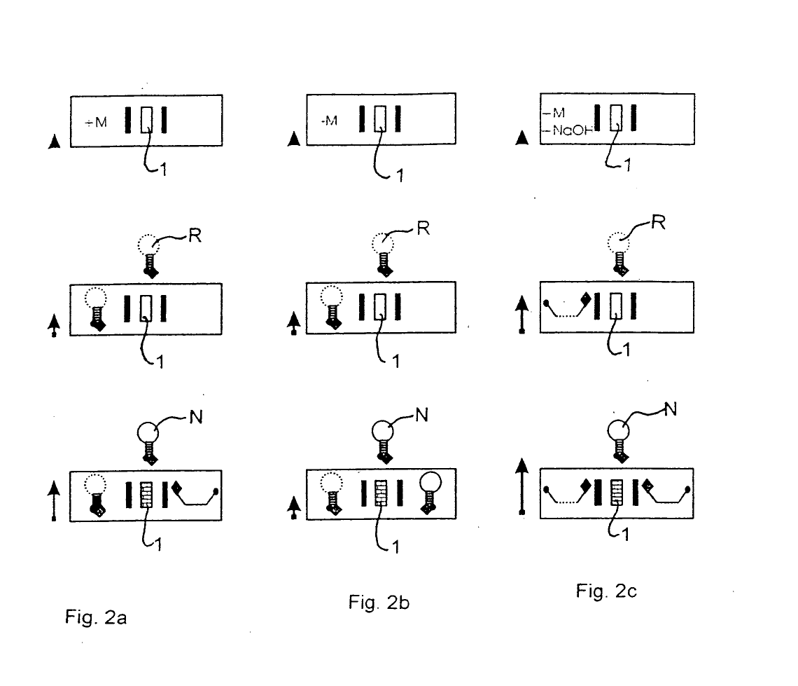

FIGS. 2a to 2c schematically, reaction variants on contacting a mark nucleic acid with a reference nucleic acid and detection nucleic acid, and

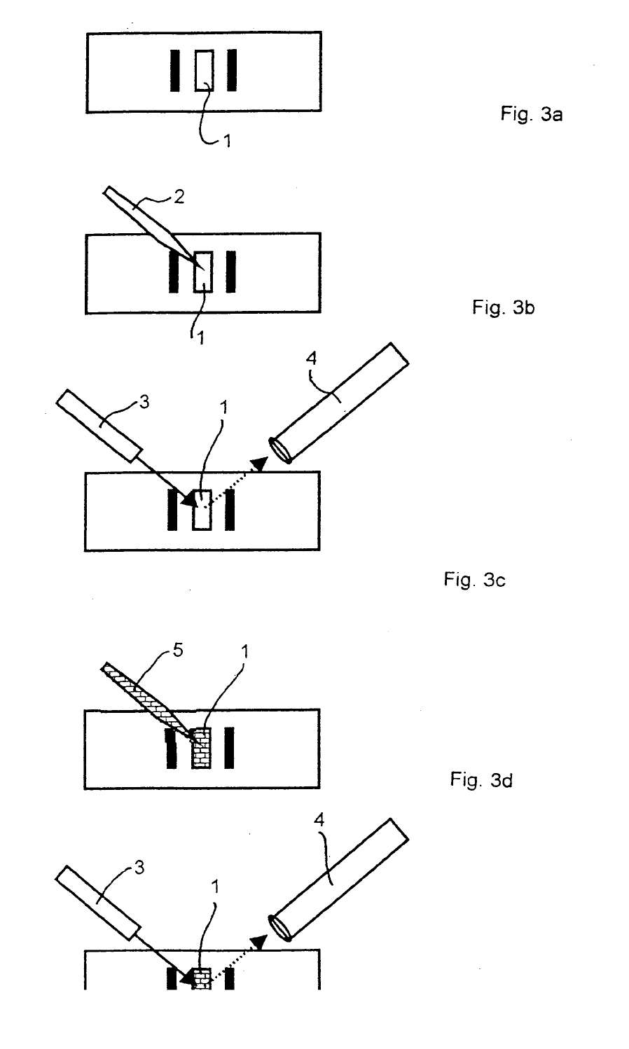

FIGS. 3a to 3e schematically, successive steps of the method.

FIG. 1 shows schematically a mark nucleic acid M, a detection nucleic acid N and a reference nucleic acid R. The detection nucleic acid N and the reference nucleic acid R are each designed as a kind of molecular beacon. The detection nucleic acid N comprises a hairpin structure, with—bound to its free ends—a first fluorophore F1 and a first quencher Q1 at a distance that quenches the fluorescence of the first fluorophore F1. Similarly, the reference nucleic acid R comprises a hairpin structure, with—bound to its free ends—a second fluorophore F2 and a second quencher Q2 at a distance that quenches the fluorescence of the second fluorophore F2.

The detection nucleic acid N is complementary, at least in sections, to the mark nucleic acid M. On contacting the detection nucleic acid N with the mark nucleic acid M, hybridization occurs. The distance that quenches the fluorescence of the first fluorophore F1 in the first quencher Q1 is cancelled. On excitation of the first fluorophore F1, fluorescence can be observed. In contrast, the reference nucleic acid R is not complementary to the mark nucleic acid M. On contacting the reference nucleic acid R with the mark nucleic acid M, hybridization does not occur. Consequently, the spatial relation between the second quencher Q2 and the second fluorophore F2 is maintained. Excitation of the second fluorophore F2 does not result in fluorescence.

The diagrams given under one another in FIG. 2a show schematically a first reaction variant, in which a mark 1 contains a mark nucleic acid M. The mark 1 is in this case free from interfering substances. It is at ambient temperature, i.e. at a temperature of 20° C.±5° C. In a first step the mark nucleic acid M is brought in contact with the reference solution. As the mark does not contain any interfering substances and is not exposed to inadmissibly high temperatures, the original structure of a reference nucleic acid R is preserved. Only a weak second fluorescence signal, if any, can be observed. In a second step a detection solution containing a detection nucleic acid N is applied on the mark 1. The detection nucleic acid N hybridizes with the mark nucleic acid M. The spatial relation between the first fluorophore and the first quencher is cancelled. A first fluorescence signal can be observed, based on which the authenticity of the mark 1 can be recognized.

In the second reaction variant shown in FIG. 2b the mark 1 does not contain mark nucleic acid M. It is free from interfering substances and is at ambient temperature. In this case, as there is no hybridization with the detection nucleic acid N, the spatial structure of the detection nucleic acid N is not altered. In this case only a weak fluorescence signal can be observed. The mark is in this case considered not authentic.

FIG. 2c shows a third reaction variant. Here, the mark 1 contains the mark nucleic acid M. The mark 1 also contains interfering substances, for example NaOH. On contacting the mark 1 with the reference nucleic acid R, the hairpin structure of the reference nucleic acid R is disrupted owing to the prevailing pH value. In this case a clear fluorescence signal can be observed. The fact that this fluorescence signal is already observed in the first step of the method indicates that the authenticity of the mark is not detectable. If additionally, in a second step, the detection solution is brought in contact with the mark, the detection nucleic acid N hybridizes with the mark nucleic acid M. A further increase in the fluorescence signal is observed. The fluorescence signal observed is composed in this case of the fluorescence signals produced both by the reference nucleic acid R and by the detection nucleic acid N. The intensity of the fluorescence signals is in this case so strong that it exceeds a predefined limit. In this case the mark 1 is once again considered not authentic.

The steps of the method according to the invention are also shown schematically in FIG. 3a to 3e. FIG. 3a shows the mark 1 according to the invention with a single mark field. The mark field consists essentially of a printed printing ink, which contains mark nucleic acid M. In the first step shown in FIG. 3b, reference solution is applied on the mark field using a first pen 2. Then the mark field is illuminated with an exciting light source 3 and any fluorescence generated is observed with a fluorescence measuring instrument 4. The fluorescence measuring instrument 4 permits, in particular, quantitative determination of the intensity of the fluorescence emitted by the mark surface.

In another subsequent step, detection solution is then applied on the single mark field using a second pen 5. As shown in FIG. 3e, the fluorescence emitted by the mark field is then determined quantitatively once again using the exciting light source 3 and the fluorescence measuring instrument 4.

The fluorescence measuring instrument 4 can be provided with a suitable evaluating device, in which threshold values and limits have been entered. Then, on the basis of the measured fluorescence intensities, this provides automatic determination of whether the mark being tested is authentic or not.

### EXAMPLE 1

Production of the Mark

In a conventional printer's ink (UV ink from the company Wolke Inks and Printers GmbH, Hersbruck, Germany, Art.-No. 690900), a nucleic acid according to sequence listing No. 1 (5′-AAGCCTGGAGGGATGATACTTTGCGCTTGG-3′) is taken up as mark nucleic acid at a concentration of 1 mg/ml. The mark nucleic acid was prepared by standard amidite solid-phase synthesis.

The printing ink is printed on an area of 4 mm×3 mm, e.g. by inkjet printing on a carrier, e.g. white paper, a suitable plastic film or the like, with a printer, e.g. using the m600 printer from the company Wolke Inks and Printers GmbH, Hersbruck, Germany. A label, which is preferably self-adhesive, can be produced from a carrier printed in this way.

Control marks without mark nucleic acid were produced by printing the printer's ink without addition of mark nucleic acid.

Detection of the Mark

For authentication of the object marked with the mark, a reference solution was applied on ten marks. For this purpose the reference solution was taken up in a first pen, which when in contact with the mark, transfers reference solution onto the mark. The reference solution is an aqueous liquid that contains, as reference nucleic acid, a nucleic acid according to sequence listing No. 3 (5′-FAM-CCG AGC CAC CAA AAA TGA TAT GCT CGG-3′-DABCYL) at a concentration of 1 μmol/l in TEN (10 mM TrisCl, pH 8; 1 mM EDTA, 100 mM NaCl, 0.19% SDS (w/v)). After recording a first fluorescence signal, the detection solution was applied on the mark. The detection solution is an aqueous liquid containing, as detecting nucleic acid, a nucleic acid according to sequence listing No. 2, 5-FAM-CCAAGCGCAAAGTATCATCCCTCCAGGCTTGG-DABCYL-. This nucleic acid is partially complementary to the mark nucleic acid according to sequence listing No. 1 contained in the mark. The detection nucleic acid was also at a concentration of 1 μmol/l in TEN (10 mM 2-amino-2-(hydroxymethyl)-1,3-propanediol (TRIS), pH 8; 1 mM EDTA, 100 mM NaCl, 0.1% SDS (w/v)). After applying the detection solution, any second fluorescence signal produced by the detection nucleic acid sequence was measured or observed.

A second fluorophore/quencher pair is bound to the free ends of the detection nucleic acid at a distance that quenches a fluorescence signal produced by the second fluorophore. The second fluorophore can for example be a fluorescence group or a derivative thereof; the second quencher can for example be Dabcyl or a Blackhole Quencher (Jena Bioscience GmbH, Loebstedter Strasse 80, D-07749 Jena, Germany). Other suitable combinations for fluorophore/quencher pairs are disclosed e.g. in Tyagi S, Bratu D P, and Kramer F R (1998) “Multicolor molecular beacons for allele discrimination”; Nat Biotechnol 16, 49-53. The reference nucleic acid can be provided with the same fluorophore/quencher pair as the detecting nucleic acid.

The detecting and reference nucleic acids were prepared by standard amidite solid-phase synthesis. In the present example the mark nucleic acid is terminally self-complementary and has a hairpin structure.

On contacting the reference solution with the mark nucleic acid, no hybridization occurs between the reference nucleic acid and the mark nucleic acid. As a result, the double-stranded structure of the reference nucleic acid is not unravelled and therefore the original spatial relation between the first fluorophore and the first quencher is not cancelled. On excitation with light at a wavelength of 492 nm, a slight fluorescence signal can be observed at 517 nm, produced in particular by the natural fluorescence of the mark nucleic acid. Measurement preferably takes place a few seconds to minutes after contact with the reference solution. Measurement can be performed using a hand-held fluorescence reader. This makes detection on the marked object possible. Hand-held fluorescence readers with the required properties can be obtained from identif GmbH, Erlangen.

On contacting the detection solution with the mark nucleic acid, hybridization occurs between the detection nucleic acid and the mark nucleic acid. As a result, the structure of the detection nucleic acid is altered and therefore the original spatial relation between the second fluorophore and the second quencher is cancelled. On excitation with light with wavelength of 492 nm, a fluorescence signal can be observed at 517 nm, which is produced by the fluorescence of the mark nucleic acid. Measurement preferably takes place a few seconds to minutes after contact with the detection solution. Measurement can be performed using a hand-held fluorescence reader. Suitable hand-held fluorescence readers can be obtained from the company identif GmbH, Erlangen.

TABLE 1

| | Signals + | | Signals − | | Signals − | |
|---|---|---|---|---|---|---|
| | mark nucleic | | mark nucleic | | mark nucleic | |
| | acid | | acid | | acid + NaOH | |
| | Reference | Detection | Reference | Detection | Reference | Detection |
| Mark | solution | solution | solution | solution | solution | solution |
| 1 | 287 | 531 | 266 | 291 | 481 | 722 |
| 2 | 293 | 540 | 257 | 289 | 472 | 699 |
| 3 | 291 | 562 | 283 | 314 | 478 | 711 |
| 4 | 278 | 545 | 280 | 317 | 495 | 725 |
| 5 | 266 | 543 | 294 | 323 | 473 | 707 |
| 6 | 285 | 563 | 289 | 327 | 481 | 720 |
| 7 | 274 | 539 | 263 | 312 | 460 | 695 |
| 8 | 293 | 543 | 282 | 317 | 492 | 723 |
| 9 | 275 | 548 | 277 | 308 | 475 | 701 |
| 10 | 284 | 560 | 283 | 321 | 471 | 697 |
| Mean | 283 | 548 | 278 | 312 | 488 | 710 |
| value | | | | | | |
| Expected | <350 | >350 | <350 | <350 | >350 | |
| value | | | | | | |

Table 1 shows the evaluation of ten marks after application of the reference and detecting nucleic acids. The value for the fluorescence of the detection nucleic acid at 517 nm is shown in the columns. Marks with and without mark nucleic acid were used. In addition, marks without mark nucleic acid were used, to which interfering substances (mark nucleic acid+NaOH) had been added.

The value for the reference nucleic acid is within a narrow range with a mean value of 283. This value corresponds to the closed structure of the reference nucleic acid, in which, owing to hybridization with the detecting nucleic acid, the first fluorophore and first quencher are spatially very closely adjacent (column on left: signals+mark nucleic acid). The value for the detection nucleic acid is within a narrow range with a mean value of 548. This value corresponds to the open structure of the detecting nucleic acid, in which—owing to hybridization with the complementary mark nucleic acid—the second fluorophore and second quencher are spatially separated. The aforementioned value also contains the signal produced by the closed structure of the reference nucleic acid (column on right: signals+mark nucleic acid).

In the columns “signals+mark nucleic acid” printed marks without mark nucleic acid were used. The value after applying the reference solution is in a range with a mean value of 278. This value corresponds to the closed structure of the reference nucleic acid, in which, because of foldback in the absence of a mark nucleic acid, the first fluorophore and first quencher are spatially closely adjacent. After applying the detection solution, the value is within a narrow range with a mean value of 312. This value corresponds to the closed structure both of the reference nucleic acid and of the detecting nucleic acid.

In the columns “mark nucleic acid+NaOH”, printed marks without mark nucleic acid were used, to which 0.5 μl of a 1-molar NaOH solution was added before contact with the reference and detecting fluids. The purpose of this addition is to simulate possible interference with the mark. The value for the reference nucleic acid is within a range with a mean value of 488. This value corresponds to the opened structure of the reference nucleic acid, in which the first fluorophore and the first quencher are spatially separated through denaturation on account of the alkaline pH. The value after application of the detection solution fluctuates around a mean value of 710. This value corresponds to the sum of the signals from the opened structure of the reference nucleic acid and the detecting nucleic acid. Owing to the denaturing effect of the alkaline pH, the detection nucleic acid also has the opened structure.

The clear separation of the fluorescence values with and without the mark nucleic acid makes it possible to establish expected values for assessing the authenticity of the mark. For example, for assessment of the mark we can set an expected value of over 350 for the detection nucleic acid and an expected value of under 350 for the reference nucleic acid. Both criteria must be fulfilled for the mark to be assessed as authentic. According to these criteria, all marks that contain mark nucleic acid (Table 1, signals+mark nucleic acid) are assessed as authentic, because all values for the detection nucleic acid are above 350 and all values for the reference nucleic acid are below 350.

Absence of the mark nucleic acid (Table 1, columns “signals−mark nucleic acid”) leads to values below 350 for the reference and detecting nucleic acids. Therefore the value of the detection nucleic acid is below the expected value. The criteria for authenticity of the mark are not fulfilled.

If there are interfering substances in the mark, the value of the fluorescence of the reference nucleic acid increases to values above the expected value for the reference nucleic acid (Table 1, column “mark nucleic acid+NaOH”). As the expected value for the reference nucleic acid is exceeded, the mark is assessed as not authentic.

1. A method of authenticating objects which are provided with a mark, said mark containing a mark nucleic acid, wherein the method comprises:
a) providing a reference solution, which contains a reference nucleic acid that is double-stranded at least in sections, wherein the reference nucleic acid strands of the reference nucleic acid are not complementary to the mark nucleic acid, and wherein a first fluorophore is bound to one reference nucleic acid strand and a first quencher is bound to the other reference nucleic acid strand at a distance that quenches a first fluorescence signal of the first fluorophore,
b) providing a detection solution that is separate from the reference solution, which contains a detection nucleic acid that is double-stranded at least in sections, wherein one of the two detection nucleic acid strands is complementary to the mark nucleic acid at least in sections, and wherein a second fluorophore is bound to one detection nucleic acid strand and wherein a second quencher is bound to the other detection nucleic acid strand at a distance that quenches a second fluorescence signal of the second fluorophore,
c1) contacting the reference solution with the mark under conditions suitable for hybridization of one of the two detection nucleic acid strands with the mark nucleic acid,
c2) observing a first fluorescence signal emitted by the mark,
d1) contacting the detection solution with the mark under the conditions as in step c1),
d2) observing a second fluorescence signal emitted by the mark and
wherein steps d1) and d2) are carried out either before or after steps c1) and c2),
and
e) establishing authenticity of the object, if (i) for the first fluorescence signal observed in step c2) at least one expected first property of the first fluorescence signal is not observed, and if (ii) the second fluorescence signal observed in step d2) corresponds to at least one expected second property of the second fluorescence signal.

2. The method as claimed in claim 1, characterized in that the first fluorophore and the first quencher are bound in the region of one end of the reference nucleic acid.

3. The method as claimed in of the preceding claims, characterized in that the second fluorophore and the second quencher are bound in the region of one end of the detecting nucleic acid.

4. The method as claimed in of the preceding claims, characterized in that steps c1) and c2) and steps d1) and d2) are carried out sequentially within 120 seconds, preferably within 60 seconds.

5. The method as claimed in any of the preceding claims, characterized in that steps c1) and c2) and steps d1) and d2) are carried out at ambient temperature.

6. The method as claimed in any of the preceding claims, characterized in that the detection nucleic acid has a hairpin structure, in which the detection nucleic acid has two mutually complementary branches.

7. The method as claimed in any of the preceding claims, characterized in that the reference nucleic acid has a hairpin structure, in which the reference nucleic acid strands have two mutually complementary branches.

8. The method as claimed in any of the preceding claims, characterized in that in step c2) and/or d2) the mark is irradiated with light of a predefined wavelength range.

9. The method as claimed in any of the preceding claims, characterized in that the mark is applied on a light-reflecting substrate.

10. The method as claimed in any of the preceding claims, characterized in that both the detection solution and the reference solution are applied on a single detection field of the mark which contains the mark nucleic acid.

11. The method as claimed in any of the preceding claims, characterized in that in each case a predefined volume of the detecting and/or the reference solution is applied on the mark.

12. The method as claimed in any of the preceding claims, characterized in that the expected first property is a predefined maximum intensity in a first wavelength range and the expected second property is a predefined minimum intensity in a second wavelength range.

13. The method as claimed in any of the preceding claims, characterized in that the first and second fluorophores are identical.

14. The method as claimed in any of the preceding claims, characterized in that the mark contains, apart from the mark nucleic acid, at least one additional nucleic acid.

15. The method as claimed in any of the preceding claims, characterized in that a printing ink containing the mark nucleic acid and/or the additional nucleic acid is used as the mark.

16. The method as claimed in any of the preceding claims, characterized in that the mark is applied by a printing process on the object to be marked or on a, preferably self-adhesive, label.

17. A kit with a first fluid dispensing device containing the reference solution,
wherein the reference solution contains a reference nucleic acid that is double-stranded at least in sections, wherein the reference nucleic acid strands of said reference nucleic acid are not complementary to a predefined mark nucleic acid, and wherein a first fluorophore is bound to one reference nucleic acid strand and a first quencher is bound to the other reference nucleic acid strand at a distance that quenches a first fluorescence signal of the first fluorophore,
and with a second fluid dispensing device containing the detection solution, wherein the detection solution contains a detection nucleic acid that is double-stranded at least in sections, wherein one of the two detection nucleic acid strands is complementary to the predefined mark nucleic acid at least in sections, and wherein a second fluorophore is bound to one detection nucleic acid strand and a second quencher is bound to the other detection nucleic acid strand, at a distance that quenches a second fluorescence signal of the second fluorophore.

18. The kit as claimed in claim 17, characterized in that the first and the second fluid dispensing device are in each case a pen or a pipette containing the detecting or reference solution.

19. A fluid dispensing device with a first container for holding the reference solution as claimed in claim 17 and a second container for holding the detection solution as claimed in claim 17, and a device for separate, sequential delivery of a predefined volume of the reference solution and of the detection solution.
